(19) United States
(12) Patent Application Publication
(10) Pub. No.: US 2018/0237266 A1
(43) Pub. Date: Aug. 23, 2018

(54) CONFIGURABLE MULTICAR ELEVATOR SYSTEM

(71) Applicant: Otis Elevator Company, Farmington, CT (US)

(72) Inventors: Tadeusz P. Witczak, Bethel, CT (US); Enrico Manes, Feeding Hills, MA (US); Zbigniew Piech, Cheshire, CT (US); Bryan R. Siewert, Clinton, CT (US)

(73) Assignee: Otis Elevator Company, Farmington, CT (US)

(21) Appl. No.: 15/751,627

(22) PCT Filed: Aug. 9, 2016
(86) PCT No.: PCT/US2016/046120

§ 371 Date: Feb. 9, 2018

Related U.S. Application Data
(60) Provisional application No. 62/203,514, filed on Aug. 11, 2015.

(51) Int. Cl. B66B 9/00; B66B 9/02; B66B 11/04

(52) U.S. Cl. CPC B66B 9/003; B66B 19/04; B66B 11/0407; B66B 9/02

(57) ABSTRACT

According to an embodiment, an elevator interface (70) for an elevator system (10) includes an external interface (74) to receive an elevator car (14) outside of the elevator system (10), and an elevator system interface (72) in operable communication with the external interface (74) to introduce the elevator car (14) into the elevator system (10).

### DESCRIPTION OF RELATED ART

The subject matter disclosed herein relates generally to the field of elevators, and more particularly to a multicar, ropeless elevator system.

Ropeless elevator systems, also referred to as self-propelled elevator systems, are useful in certain applications (e.g., high rise buildings) where the mass of the ropes for a roped system is prohibitive, roped elevator core space can become too large, and there is a desire for multiple elevator cars to travel in a single lane. There exist ropeless elevator systems with multiple lanes in which some lanes are designated for upward traveling elevator cars and some lanes are designated for downward traveling elevator cars. Transfer stations at various locations in the hoistway are used to move elevator cars horizontally between these various upward and downward moving lanes.

Ropeless elevator systems are often used for variety of applications and users. Certain applications and users have different objectives, requirements, and desires requiring the use or replacement of elevator cars within the elevator system. Further, elevator car selection and installation can be expedited by utilizing elevator cars that are provided from outside the elevator system. A system and method that can selectively introduce and remove elevator cars from a ropeless elevator system is desired to optimize performance and service.

### BRIEF SUMMARY

According to an embodiment, an elevator interface for an elevator system includes an external interface to receive an elevator car outside of the elevator system, and an elevator system interface in operable communication with the external interface to introduce the elevator car into the elevator system.

In addition to one or more of the features described above, or as an alternative, further embodiments could include an elevator car storage area associated with the external interface and the elevator system interface to store the elevator car.

In addition to one or more of the features described above, or as an alternative, further embodiments could include that the elevator system interface removes the elevator car from the elevator system and the external interface provides the elevator car to outside the elevator system.

In addition to one or more of the features described above, or as an alternative, further embodiments could include that the at least one elevator system interface aligns the at least one elevator car for use with the elevator system.

In addition to one or more of the features described above, or as an alternative, further embodiments could include that the at least one elevator car is a specialized elevator car.

In addition to one or more of the features described above, or as an alternative, further embodiments could include that the at least one elevator car is pre-aligned outside the elevator system.

In addition to one or more of the features described above, or as an alternative, further embodiments could include that the at least one elevator system interface includes a lift to introduce and receive the at least one elevator car.

In addition to one or more of the features described above, or as an alternative, further embodiments could include that the at least one elevator car is preassembled outside the elevator system.

According to an embodiment, a method for operating an elevator system includes receiving an elevator car from outside the elevator system to an external interface, and introducing the elevator car into the elevator system from an elevator system interface in operable communication with the external interface.

In addition to one or more of the features described above, or as an alternative, further embodiments could include storing the elevator car in an elevator car storage area in operable communication with the external interface and the at least one elevator system interface.

In addition to one or more of the features described above, or as an alternative, further embodiments could include removing the elevator car from the elevator system via the elevator system interface, and providing the elevator car to outside the elevator system via the at least one external interface.

In addition to one or more of the features described above, or as an alternative, further embodiments could include aligning the at least one elevator car for use with the elevator system using the at least one elevator system interface.

In addition to one or more of the features described above, or as an alternative, further embodiments could include that the at least one elevator car is a specialized elevator car.

In addition to one or more of the features described above, or as an alternative, further embodiments could include pre-aligning the elevator car outside the elevator system.

In addition to one or more of the features described above, or as an alternative, further embodiments could include preassembling the elevator car outside the elevator system.

Technical function of the embodiments described above includes an external interface to receive an elevator car outside of the elevator system, and an elevator system interface in operable communication with the external interface to introduce the elevator car into the elevator system.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 depicts a multicar elevator system;

FIG. 2 shows an elevator interface for use with a multicar elevator system, such as the system depicted in FIG. 1;

FIG. 3 shows the elevator interface for use in a multicar elevator system, such as the system depicted in FIG. 1; and

FIG. 4 shows a method to utilize cars from outside the elevator system.

### DETAILED DESCRIPTION

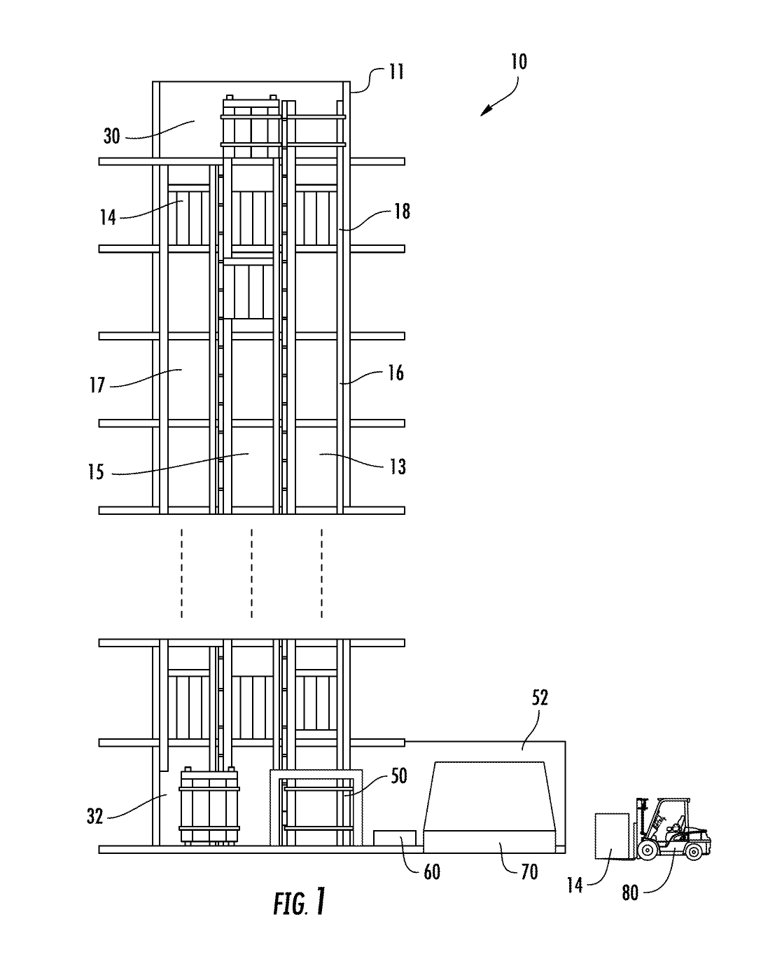

FIG. 1 depicts a multicar, ropeless elevator system 10. The elevator system 10 includes a hoistway 11 having a plurality of lanes 13, 15 and 17. In an embodiment, elevator system 10 may include modular components that can be associated to form an elevator system. Modular components can include, but are not limited to a landing floor hoistway, a shuttle floor hoistway, a transfer station, a carriage, a parking area, a disengaging mechanism, and the like. While three lanes are shown in FIG. 1, it is understood that the elevator system 10 can include any number of lanes. In each of the plurality of lanes 13, 15, 17, an elevator car 14 can travel in one direction, e.g., up or down. For example, in FIG. 1 elevator cars 14 in lanes 13 and 15 travel up and elevator cars 14 in lane 17 travel down. One or more elevator cars 14 may travel in a single lane 13, 15, and 17. In an embodiment, the elevator car 14 can move bi-directionally within a lane 13, 15, and 17. The lanes 13, 15, and 17 can support shuttle functionality during certain times of the day, such as peak hours, allowing unidirectional, selective stopping, or switchable directionality as desired. In an embodiment, lanes 13, 15, and 17 can include localized directionality, wherein certain areas of lanes 13, 15, 17 and hoistway 11 are assigned to various functions and building portions. In an embodiment, the elevator car 14 can circulate in a limited area of hoistway 11. In an embodiment, the elevator car 14 can operate at a reduced velocity to reduce operating and equipment costs. In an embodiment, the hoistways 11 and lanes 13, 15, 17 can operate in a mixed mode operation wherein portions of hoistway 11 and lanes 13, 15, 17 operate normally (unidirectional or bidirectional) and other portions operate in another manner, including but not limited to, unidirectional, bidirectional, or in a parking mode.

In an embodiment, the elevator system 10 can include an upper transfer station 30 (e.g., located above the top floor) which can allow for movement of an elevator car 14 between lanes 13, 15 and 17. The upper transfer station 30 and lower transfer station 32 in addition to other transfer stations and loading stations 50 can be disposed at any suitable location. It is understood that upper transfer station 30 may be located at the top floor, rather than above the top floor. The elevator system 10 can include a lower transfer station 32 (e.g., located below the bottom floor) which can allow for movement of an elevator car 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32. Any method for imparting a horizontal motion to the elevator cars 14 to move elevator cars 14 between lanes 13, 15 and 17 can be employed in such a transfer station 30. For example, such methods can include the primary propulsion system of the elevator car 14, a separate propulsion system adapted for movement of an elevator car 14 through the transfer station 30, or a combination thereof. The elevator car 14 can be propelled using any method of propulsion, for example, a rotary motor system or a linear motor system having a primary, fixed portion 16 and a secondary, moving portion 18. One or more fixed portions 16 are mounted in lanes 13, 15 and 17. One or more moving portions 18 are mounted on elevator cars 14. One of the motor portions is supplied with drive signals to control movement of elevator cars 14 in their respective lanes. In an embodiment, lanes of hoistway 11 can be shut down or restricted based on operator input or elevator system conditions.

In an embodiment, elevator system 10 includes an elevator interface 70 to allow the introduction of elevator cars 14 from outside of the elevator system 10. In the illustrated embodiment, the elevator interface 70 allows elevator cars 14 to be received from an outside elevator car source 80. Further, the elevator interface 70 allows elevator cars 14 to be received by the loading station 50 to be introduced into the elevator system 10. In an embodiment, the elevator interface 70 can further provide elevator cars 14 to be removed to the outside elevator car source 80. In the illustrated embodiment, the elevator interface 70 is disposed within the interface area 52. In an embodiment, the elevator cars 14 can be assembled in an on-site location, such as the interface area 52 or within the loading station 50, but outside of the hoistway 11 of the elevator system 10. In an embodiment, the elevator cars 14 that are assembled in an on-site location but outside of the hoistway 11 can be considered elevator cars 14 that are outside of the elevator system 10 and can be introduced by the elevator interface 70.

Advantageously, the elevator interface 70 allows for elevator cars 14 to be introduced from a source external to the elevator system 10 or removed from the elevator system 10. The elevator interface 70 allows for elevator cars 14 to be provided from an off-site source 80. In the illustrated embodiment, the elevator cars 14 provided to the elevator system 10 via the elevator interface 70 can be preassembled at an offsite location, such as an elevator car manufacturer or any other suitable party. By providing preassembled elevator cars 14, elevator cars 14 can be assembled in a manufacturing environment instead of within the hoistways 11 of the elevator system 10. In an embodiment, elevator cars 14 can be stored in an assembled state at an offsite storage facility. In an embodiment, additional elevator cars 14 can be provided as system 10 demand increases, and then removed from the system 10 as demand decreases. In an embodiment, the elevator cars 14 can be transferred to be serviced at an external location.

In the illustrated embodiment, at least some of the elevator cars 14 can be custom elevator cars 14 that are delivered to the elevator interface 70 as desired. Such custom elevator cars can be utilized for specific purposes, such as limited access, repair, maintenance, extra load capability, usage by specific persons (e.g., VIP usage), and the like. In an embodiment, custom or specialized elevator cars 14 can be introduced or removed from the elevator system as required. The custom or specialized elevator cars 14 can be available for special needs such as inspections, installation, construction, service, transport of selected individuals and the like.

In the illustrated embodiment, elevator cars 14 can be pre-aligned at an offsite location to facilitate the rapid introduction and removal of elevator cars 14 from the elevator system 10 via the elevator interface 70. In an embodiment, the elevator cars 14 can be aligned within the elevator interface 70 before introduction into the elevator system 10. In an embodiment, the elevator cars 14 can be pre-adjusted for other characteristics, including, but not limited to, propulsion calibration, guidance calibration, and the like. Adjustments may be made relative to previously determined values, references, or a combination thereof.

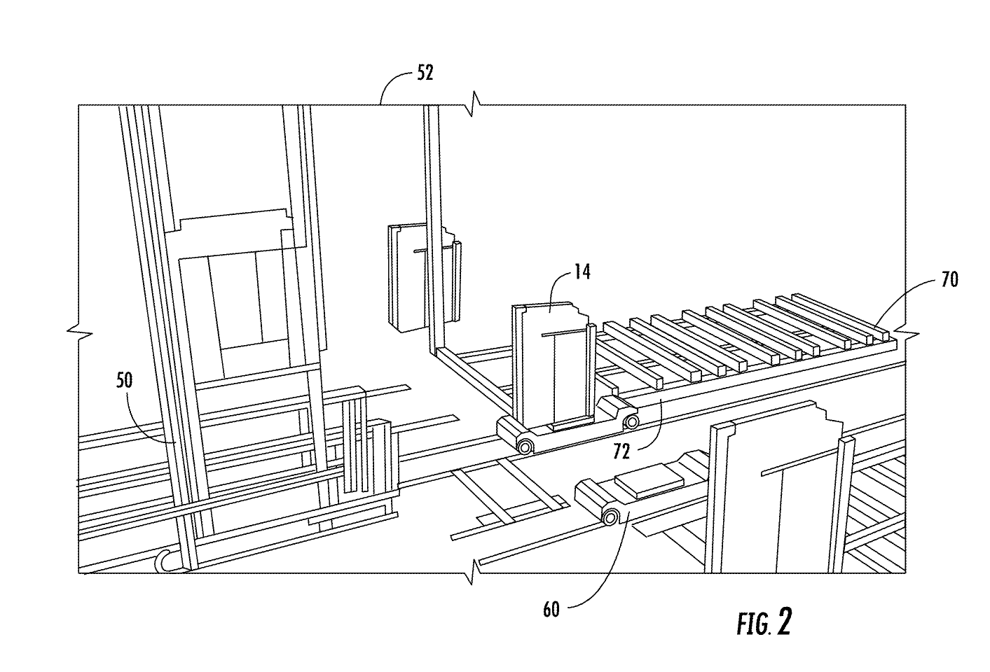

Referring to FIG. 2, the interface area 52 is shown. In the illustrated embodiment, the interface area 52 contains the loading station 50 and the elevator interface 70. In the illustrated embodiment, the elevator interface 70 can provide elevator cars 14 to the loading station 50.

In the illustrated embodiment, the loading station 50 can introduce elevator cars 14 into circulation within the hoistways 11. The loading station 50 can also remove elevator cars 14 from the hoistway 11. Such elevator cars 14 can be stored in a dedicated parking area, or can be handled by the elevator interface 70. In an embodiment, the transport device 60 can utilize a any suitable lift, such as a fork lift, a hoist, or a scissor lift to raise or otherwise convey the elevator cars 14 between the loading station 50 and the elevator interface 70.

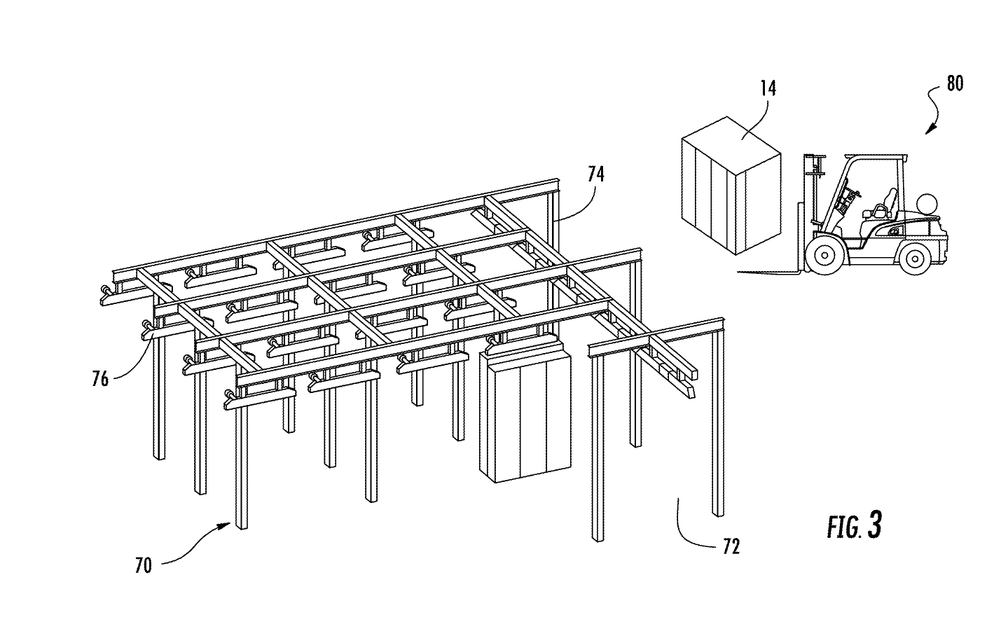

Referring to FIG. 3 the elevator interface 70 is shown. In the illustrated embodiment, the elevator interface 70 includes an elevator system interface 72 and an external interface 74. Advantageously, the elevator interface 70 allows for elevator cars 14 to be introduced from outside the elevator system 10 without the use of any external equipment such as cranes. In an embodiment, the elevator interface 70 can include a realigning device, such as adjustable cams to adjust the alignment of the elevator cars 14. In an embodiment, the elevator interface 70 includes the elevator system interface 72 in operable communication with the external interface 74 to allow the passage and transport of elevator cars 14 therebetween.

In the illustrated embodiment, the external interface 74 can receive elevator cars 14 from the external source 80. In an embodiment, the external source can include, but is not limited to manufacturers, storage, other elevator systems, a delivery truck, and the like. In an embodiment, the external source 80 can utilize a fork lift or a scissor lift to raise or otherwise convey the elevator cars 14 to the external interface 74. Further, in an embodiment, the external interface 74 can provide elevator cars 14 to the external source 80. In the illustrated embodiment, the external interface 74 can receive an elevator car 14 from an external source 80 and transport the elevator car 14 via an upper attachment as shown in FIG. 3 or via a lower transport as shown in FIG. 2.

In the illustrated embodiment, the elevator system interface 72 can provide elevator cars 14 from the external source 80 to the loading station 50. Further the elevator system interface 72 can receive elevator cars 14 from the loading station 50. In the illustrated embodiment, the elevator interface 72 can receive an elevator car 14 from the external interface 74 and transport the elevator car 14 via an upper attachment as shown in FIG. 3 or via a lower transport as shown in FIG. 2. In an embodiment, the elevator system interface 72 can be in direct communication with the hoistway 11. In an embodiment, the transport device 60 can utilize a fork lift or a scissor lift to raise or otherwise convey the elevator cars 14 between the loading station 50 and the elevator system interface 72. In an embodiment, the elevator interface 72 can be a direct path from an external source 80 to the loading station 50 or the hoistway 11. In an embodiment, the elevator system interface 72 can operate in a “new elevator car installation” mode, wherein the elevator system interface 72 can operate at a reduced speed or provide for manual control.

Advantageously, the elevator system interface 72 can insert the elevator cars 14 with high precision and satisfy the alignment required for elevator system 10 to operate. In an embodiment, the elevator system interface can utilize an encoded alignment specification for a received elevator car 14 to determine the relative alignment of the elevator car 14 within the elevator system 10. Alignment encoding can include high resolution information, such as alignment of elevator car 14 within the hoistway 11 and low resolution information such as alignment of the elevator car 14 in parking or storage locations. Advantageously, the elevator system interface 72 can facilitate plug and play type functionality (e.g., where little or no adjustment to the elevator car 14 is needed prior to introducing it into the hoistway 11) for elevator cars 14 received from an external source. The elevator system interface 72 can verify alignment before introducing elevator cars 14 to the elevator system 10.

In an embodiment, the elevator interface 70 can include an elevator car storage area 76. The elevator car storage area 76 can interact with the elevator cars 14 overhead as shown in FIG. 3, or from below the elevator cars 14 as shown in FIG. 2, or from a side of the elevator car 14. In an exemplary embodiment, the elevator car storage area 76 can include transport mechanisms such as, pallets, rollers, hangers, and the like. In an embodiment, the elevator car storage area 76 can facilitate the partial or complete assembly and disassembly of elevator cars 14. In an example embodiment, elevator cars 14 that are to be stored are stored in storage area 76. In an embodiment, storage area 76 is any suitable area, including, but not limited to areas with sufficient space to move the elevator cars 14 therein. Elevator cars 14 may be assembled, stored, and maintained in certain positions that allow for increased accessibility for assembly, maintenance, and repair. Elevator cars 14 are delivered and retrieved from storage area 76 via either the elevator system interface 72 or the external interface 74.

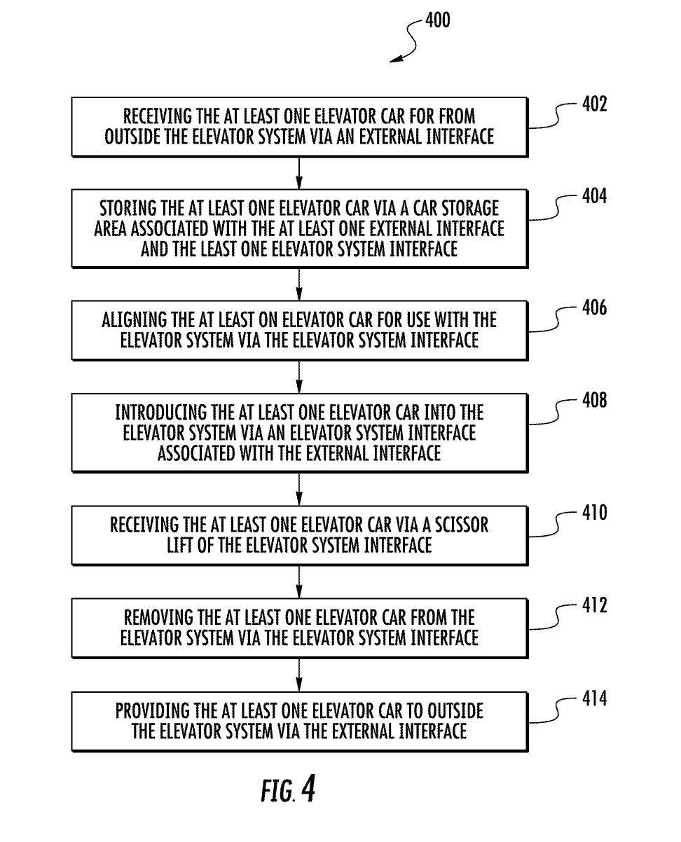

Referring to FIG. 4, a method 400 for utilizing elevator cars from outside the elevator system is shown. In operation 402, at least one elevator car 14 from outside the elevator system 10 is received via an external interface 74. In the illustrated embodiment, the external interface 74 can receive elevator cars 14 from the external source 80, such as a manufacturer, warehouse, etc.

In operation 404, the elevator car 14 can be stored via an elevator car storage area 76 associated with the at least one external interface 74 and the at least one elevator system interface 72. While in storage, the elevator car 14 may be parked or prepared for use in the elevator system 10. In an embodiment, an initial alignment procedure may be performed utilizing low resolution or preliminary adjustments.

In operation 406, the elevator system interface 72 aligns the at least one elevator car 14 for use with the elevator system 10. Advantageously, the elevator system interface 72 can insert the elevator cars 14 with high precision to allow for the alignment required for elevator system 10 to operate. In an embodiment, the elevator system interface 72 can utilize an encoded alignment specification for a received elevator car 14 to determine the relative alignment of the elevator car 14 within the elevator system 10. Alignment encoding can include high resolution information, such as alignment of elevator car 14 within the hoistway 11 and lower resolution information such as alignment of the elevator car 14 in parking or storage locations. Advantageously, the elevator system interface 72 can facilitate plug and play type functionality for elevator cars 14 received from an external source 80. The elevator system interface 72 can verify alignment before introducing elevator cars 14 to the elevator system 10. In an embodiment, the alignment can be performed manually, mechanically, electromechanically, pneumatically, etc.

In operation 408, the at least one elevator car 14 is introduced into the elevator system 10 via an elevator system interface 72. Advantageously, the elevator system interface 72 can insert the elevator cars 14 with high precision to allow for the alignment required for elevator system 10 to operate as described above.

In an embodiment, the at least one elevator car 14 is not removed from the elevator system 10. In other embodiments, the elevator car 14 is removed independently of the addition of another elevator car 14. In operation 410, the at least one elevator car 14 is received via a transport device 60 of the elevator system interface 72. In an embodiment, the transport device 60 can utilize a fork lift or a scissor lift to raise or otherwise convey the elevator cars 14 between the loading station 50 and the elevator system interface 72.

In operation 412, the at least one elevator car 14 is removed from the elevator system 10 via the elevator system interface 72.

In operation 414, the at least one elevator car 14 is provided to outside the elevator system 10 via the external interface 74. Further, in an embodiment, the external interface 74 can provide elevator cars 14 to the external source 80 to be removed to an off-site location.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include any number of the described embodiments. Accordingly, the embodiments are not to be seen as limited by the foregoing description, but are only limited by the scope of the appended claims. The terms “a” and “an” and “the” herein do not denote a limitation of quantity, and are to be construed to cover both the singular and the plural, unless otherwise indicated herein or clearly contradicted by context.

1. An elevator interface for an elevator system, comprising:
an external interface to receive an elevator car outside of the elevator system; and
an elevator system interface in operable communication with the external interface to introduce the elevator car into the elevator system.

2. The elevator interface of claim 1, further comprising an elevator car storage area associated with the external interface and the elevator system interface to store the elevator car.

3. The elevator interface of claim 1, wherein the elevator system interface removes the elevator car from the elevator system and the external interface provides the elevator car to outside the elevator system.

4. The elevator interface of claim 1, wherein the at least one elevator system interface aligns the at least one elevator car for use with the elevator system.

5. The elevator interface of claim 1 wherein the at least one elevator car is a specialized elevator car.

6. The elevator interface of claim 1 wherein the at least one elevator car is pre-aligned outside the elevator system.

7. The elevator interface of claim 1 wherein the at least one elevator system interface includes a lift to introduce and receive the at least one elevator car.

8. The elevator interface of claim 1, wherein the at least one elevator car is preassembled outside the elevator system.

9. A method for operating an elevator system, comprising:
receiving an elevator car from outside the elevator system to an external interface; and
introducing the elevator car into the elevator system from an elevator system interface in operable communication with the external interface.

10. The method of claim 9, further comprising storing the elevator car in an elevator car storage area in operable communication with the external interface and the at least one elevator system interface.

11. The method of claim 9, further comprising:
removing the elevator car from the elevator system via the elevator system interface; and
providing the elevator car to outside the elevator system via the at least one external interface.

12. The method of claim 9, further comprising aligning the at least one elevator car for use with the elevator system using the at least one elevator system interface.

13. The method of claim 9 wherein the at least one elevator car is a specialized elevator car.

14. The method of claim 9, further comprising pre-aligning the elevator car outside the elevator system.

15. The method of claim 9, further comprising preassembling the elevator car outside the elevator system.
